(19) United States
(12) Patent Application Publication
(10) Pub. No.: US 2009/0086603 A1
(43) Pub. Date: Apr. 2, 2009

(54) LIGHT EMITTING ELEMENT DRIVE CIRCUIT AND INFORMATION RECORDING/REPRODUCING APPARATUS USING SUCH CIRCUIT

(75) Inventor: Kazuto KURODA, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/206,998

(22) Filed: Sep. 9, 2008

(30) Foreign Application Priority Data
Sep. 28, 2007 (JP) 2007-256618

(51) Int. Cl. G11B 7/00

(52) U.S. Cl. 369/100

(57) ABSTRACT

According to one embodiment, a first switching element which switches a light source, a second switching element which switches a load element connected in parallel to the light source, and a switch which controls the connection between the first and second switching elements and a constant current source. When the first switching element and the second switching element are differentially operated by the switch, the switch is turned on a predetermined time earlier than the turning on of the first or second switching element.

### CROSS-REFERENCE TO RELATED APPLICATIONS

This application is based upon and claims the benefit of priority from Japanese Patent Application No. 2007-256618, filed Sep. 28, 2007, the entire contents of which are incorporated herein by reference.

### BACKGROUND

1. Field

One embodiment of the present invention relates to a light emitting element drive circuit and an information recording/reproducing apparatus using the light emitting element drive circuit which enable recording by sub-nanosecond class pulse laser with a low duty ratio.

2. Description of the Related Art

As is well known, a digital versatile disc (DVD) has been available as an optical disc for storing digital images, and is widely used all over the world mainly for storing and distributing movie contents (digital work publications). There have also been realized discs having higher capacities than the above-mentioned DVD (referred to as an existing DVD).

As a method of recording on such optical discs, there has been developed a recording method which uses a sharp recording pulse having a length smaller than 1 ns to perform recording with smaller light energy. This recording method is called, for example, a sub-nanosecond pulse recording method, or a recording method using relaxation oscillation.

Lower power consumption can be expected in the recording method using the relaxation oscillation. However, when this method is employed, it is not known whether information is recorded on or reproduced from an optical disc with sufficiently satisfactory quality. Moreover, occurrence of new problems is anticipated due to the use of the relaxation oscillation.

On the other hand, in order to reduce noise of semiconductor laser produced when information is recorded on or reproduced from the optical disc, various techniques have been developed as techniques for driving the semiconductor laser.

For example, Japanese Patent Application Publication (KOKAI) No. Hei 11-4033 shows the use of a bias supply circuit in high-velocity switching of a light emitting element (laser diode) in order not to completely turn off a constant current source circuit during switch-off (a current lower than a light emission drive current is continuously passed by the bias supply circuit even during switch-off).

In the light emitting element drive circuit described in the above-mentioned publication, a current lower than the light emission drive current is continuously passed by the bias supply circuit even during switch-off, so that the power consumption is not perfectly zero even when there is no light emission.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information reproducing apparatus (an optical disc apparatus) according to an embodiment of the invention;

FIG. 2 is an exemplary diagram showing an example of a laser modulation control circuit used in the optical disc apparatus shown in FIG. 1, according to an embodiment of the invention;

FIG. 3 is an exemplary diagram showing an example of a light emitting element drive circuit using the laser modulation control circuit shown in FIG. 2, according to an embodiment of the invention;

FIG. 4 is an exemplary diagram showing an example of the relation among a laser diode, a dummy load diode and on/off of a current of a current source in the light emitting element drive circuit shown in FIG. 3, according to an embodiment of the invention; and

FIG. 5 is an exemplary diagram showing an example of the relation between data (NRZI) recorded using sub-nanosecond pulse recording of the present embodiment and a corresponding drive current waveform of a laser element, in an information reproducing apparatus (an optical disc apparatus) according to an embodiment of the invention.

### DETAILED DESCRIPTION

Various embodiments according to the invention will be described hereinafter with reference to the accompanying drawings. In general, according to one embodiment of the invention, a light emitting element drive circuit includes a first switching element which switches a light source, a second switching element which switches a load element connected in parallel to the light source, and a switch which controls the connection between the first and second switching elements and a constant current source.

Embodiments of this invention will be described in detail with reference to the drawings.

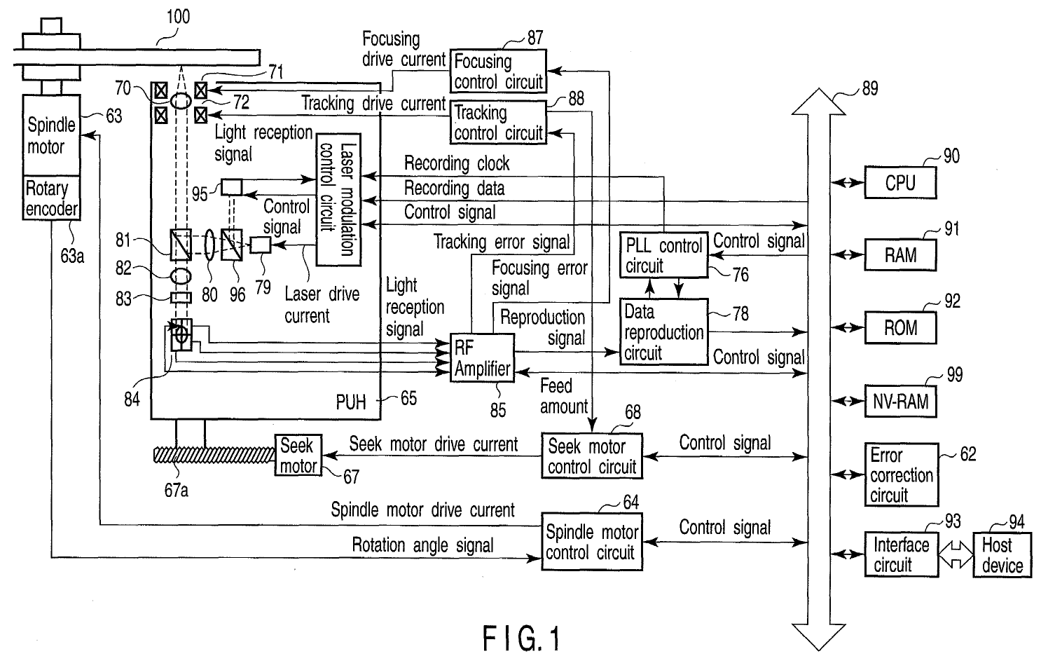

FIG. 1 is a block diagram showing one example of the configuration of an information recording/reproducing apparatus (optical disc drive) to which the present invention is applicable.

The information recording/reproducing apparatus (optical disc drive) records information in a recording surface of an information recording medium (optical disc) 100 or reproduces information recorded in the recording surface.

A concentric or spiral groove is cut in the recording surface of the optical disc 100. A concave portion of the groove is called a land while a convex portion of the groove is called a groove, and one round of the groove or land is called a track.

Laser light whose strength has been modulated is applied along the track (the groove alone or the groove and land) to form a recording mark, such that user data is recorded. The reproduction of the data is achieved by applying laser light of read power weaker than that in recording along the track and thereby detecting a change in the strength of light reflected by the recording mark on the track.

The erasure of recorded data can be achieved by applying laser light of erase power stronger than that of the read power along the track and thereby crystallizing a recording layer.

The optical disc 100 is rotated at a predetermined velocity by a spindle motor 63.

A rotation angle signal is output from a rotary encoder 63A provided in the spindle motor 63. One rotation of the spindle motor 63 produces, for example, five pulses of the rotation angle signal. By this rotation angle signal, a spindle motor control circuit 64 judges the rotation angle and rotation number of the spindle motor 63.

The recording of information on the optical disc 100 and the reproduction of information from the optical disc 100 are achieved by an optical pickup (hereinafter, a pickup head, PUH) 65.

The PUH 65 is coupled to a feed motor 67 via a gear and a screw shaft. The feed motor 67 is controlled by a feed motor control circuit 68. The feed motor 67 is rotated by a feed motor drive current from the feed motor control circuit 68, such that the optical head 65 moves in the radial direction of the optical disc 100.

The PUH 65 is provided with an objective lens 70 which is supported by a wire spring (not shown) or a leaf spring (not shown) to be movable over a predetermined distance in a direction perpendicular to the recording surface of the optical disc 100 or in the radial direction of the optical disc 100. The objective lens 70 can be moved in a focusing direction (the direction perpendicular to the recording surface, i.e., the optical axis direction of the objective lens 70) by the driving of a drive coil 72, and can also be moved in a tracking direction (the radial direction of the optical disc 100, i.e., a direction perpendicular to the optical axis of the objective lens 70) by the driving of a drive coil 71.

In recording information (the formation of a mark), a laser modulation control circuit 75 supplies a write signal to a laser diode (laser light emitting element) 79 on the basis of recording data supplied from a host device 94 via an interface circuit 93.

The laser light generated by the laser diode 79 enters a half-mirror 96. The half-mirror 96 branches the laser light generated by the laser diode 79 by a fixed ratio.

A monitor light detector (FM-PD) 95 configured by a photodiode receives part of the laser light from the half-mirror 96. The monitor light detector (FM-PD) 95 detects part of the laser light proportionate to irradiation power, and supplies a light reception signal to the laser modulation control circuit 75.

The laser modulation control circuit 75 controls the laser diode 79 on the basis of the strength of reflection laser light received by the monitor light detector 95 so that reproduction laser power, recording laser power and erase laser power that have been set by a main arithmetic processing block 90 including a central processing unit (CPU) may be suitably obtained.

The laser diode 79 generates laser light in accordance with a drive current supplied from the laser modulation control circuit 75. The laser light emitted from the laser diode 79 is applied onto the optical disc 100 via a collimator lens 80, a half-prism 81 and the objective lens 70. Reflection light from the optical disc 100 is guided to a photodetector 84 via the objective lens 70, the half-prism 81, a collecting lens 82 and a cylindrical lens 83.

The photodetector 84 includes, for example, four photodetector cells, and detection signals of these photodetector cells are output to an RF amplifier 85. The RF amplifier 85 processes the signals from the photodetector cells, and generates a focusing error signal FE indicating a deviation from a focal position, a tracking error signal TE indicating a difference between the beam spot center of the laser light and the center of the track, and a reproduction signal which is a total sum signal of the signals of the photodetector cells.

The focusing error signal FE is supplied to a focusing control circuit 87. The focusing control circuit 87 generates a focusing drive (control) signal in accordance with the focusing error signal FE. The focusing drive signal is supplied to the drive coil 71 in the focusing direction. Thus, the position of the PUH 65 is set by control called focusing servo whereby the minimum spot of the laser light which is given convergence properties by the objective lens 70 incorporated in the PUH 65 moves to coincide with be just in focused the recording film of the optical disc 100.

The tracking error signal TE is supplied to a tracking control circuit 88. The tracking control circuit 88 generates a tracking drive signal in accordance with the tracking error signal TE. The tracking drive (control) signal output from the tracking control circuit 88 is supplied to the drive coil 72 in the tracking direction. Thus, the position of the PUH 65 is controlled so that the laser light always traces on the track formed on the optical disc 100, by control called a tracking servo whereby the PUH 65 moves in the radial direction of the optical disc 100.

Such focusing servo and tracking servo are performed, such that the change of the reflection light from, for example, a recording mark formed on the track of the optical disc 100 in accordance with recording information is reflected in a total sum signal RF of the output signals from the photodetector cells of the photodetector 84. This signal is supplied to a data reproduction circuit 78. The data reproduction circuit 78 reproduces the recording data on the basis of a reproduction clock signal from a PLL circuit 76.

When the objective lens 70 is controlled by the tracking control circuit 88, the position of the feed motor 67, that is, the position of the optical head (PUH) 65 is also controlled by the feed motor control circuit 68 so that the objective lens 70 is located in the vicinity of a predetermined position within the optical head 65.

The spindle motor control circuit 64, the feed motor control circuit 68, a laser control circuit 73, the phase locked loop (PLL) circuit 76, the data reproduction circuit 78, the focusing control circuit 87, the tracking control circuit 88, an error correction circuit 62, etc. are controlled by the main arithmetic processing block (CPU) 90 via a bus 89. The CPU (main arithmetic processing block) 90 controls the overall operation of the recording/reproducing apparatus in accordance with operation commands provided from the host device 94 through the interface circuit 93. Moreover, the CPU 90 uses a random access memory (RAM) 91 as a working area, and performs a predetermined operation in accordance with a control program including a program by the present invention recorded in a read-only memory (ROM) 92 by appropriately referring to a parameter for each individual apparatus recorded in a nonvolatile random access memory. In addition, it goes without saying that the error correction circuit 62 corrects errors in the reproduction signal.

On the other hand, as a method of recording information on a recording medium, that is, an optical disc by the optical disc drive (information recording/reproducing apparatus) as shown in FIG. 1, “sub-nanosecond pulse recording” is coming into practical use which uses a sharp recording pulse of a length smaller than 1 nanosecond (ns) to carry out recording with smaller light energy.

The “sub-nanosecond pulse recording” requires performance of the recording pulse in which the rise/fall time of an LD drive current pulse for the laser diode is less than 100 picoseconds (ps).

In addition, while the field of optical communications is known to use pulse laser light with a recording pulse length smaller than 1 ns, a circuit is used in most cases to differentially turn on/off a transistor and thus switch the path of a current flowing to a current source.

However, in such a configuration, since the turning on/off of the current to the laser diode is replaced with the switching of the current path, a current is passed to a dummy load (a resistor and the laser diode themselves, or the resistor and a diode simulating the laser diode) when no current is passed to the laser diode, so that a wasteful current which does not contribute to the emission of the laser diode flows.

Furthermore, the “sub-nanosecond pulse recording” satisfies the requirements for the rise time/fall time, but the duty ratio, that is, the ratio of on-time of the laser emission of the “sub-nanosecond pulse recording” is often less than 10%, such that, for example, over 90% of electric power is consumed by the dummy load.

In addition, a modulation current in the “sub-nanosecond pulse recording” may be about 500 mA, so that 5V×0.5 A×0.9=25W or more results in heat if a 5V power source is used to drive the laser diode. This heat is locally generated around a laser diode driver (including the dummy load when the dummy load is externally provided), and how to release this heat, and the thermal effect on optical components for optical disc recording/reproduction are therefore major problems.

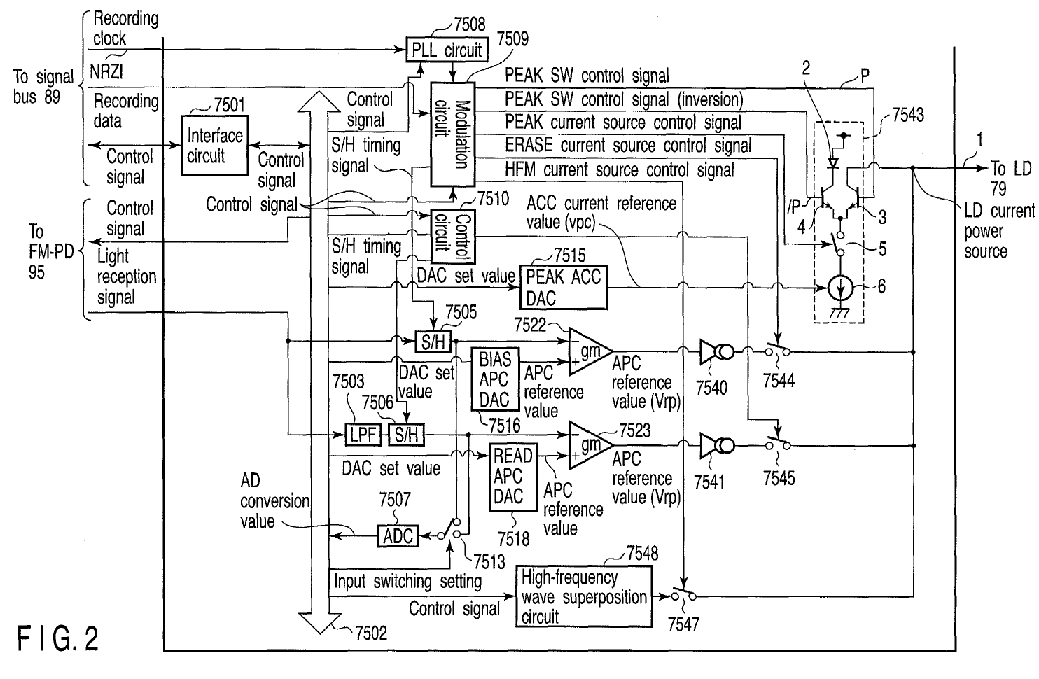

Next, the laser modulation control circuit incorporated in the optical disc drive (information recording/reproducing apparatus) shown in FIG. 1 is described in detail with FIG. 2.

As shown in FIG. 2, the laser modulation control circuit 75 is separated into a waveform generating unit for generating a recording waveform from a recording clock and recording data and switching a current source accordingly, an APC operation unit for controlling the current to the laser diode (LD) 79 so that irradiation power ordered from the CPU 90 is obtained during recording/reproduction, and a control unit for interpreting a control signal from the signal bus 89 and controlling the laser modulation control circuit.

In reproduction, the APC operation unit compares, by a comparison amplifier 7522, a light reception signal input from an FM-PD 95 through an LPF 7503 for noise elimination and through a sample-and-hold circuit S/H 7506 for holding the state of reproduction during recording, with an output of a read digital-to-analog converter (READ APC DAC) 7518 in which there has been set READ irradiation power information contained in the control signal input from the CPU 90 via the signal bus 89. Then, the APC operation unit controls a current source 7540 so that it coincides with the READ irradiation power, and adjusts a LD drive current supplied to the laser diode 79.

In recording, (the APC operation unit) loads the light reception signal from the FM-PD 95 in a space portion by a sample-and-hold circuit S/H 7505, and compares, by the comparison amplifier 7522, the light reception signal from the FM-PD 95 with an output of a bias digital-to-analog converter (BIAS APC DAC) 7516 in which there has been set space portion irradiation power information contained in the control signal input from the CPU 90 via the signal bus 89. Then, the APC operation unit controls the current source 7540 so that irradiation power at which BIAS switch 7544 is turned on coincides with the set space portion irradiation power. In addition, at this point, a waveform in which high-frequency wave superposition is averaged is input to the sample-and-hold circuit S/H 7505 owing to a low-pass filter effect attributed to the band limitation of the FM-PD 95.

In addition, there is also a method of performing APC operation by the CPU 90 instead of the comparison amplifier of the laser modulation control circuit 75. For example, the CPU 90 may switch to the output of the S/H 7505 or S/H 7506 by an input switch switch 7513 to input the output to an analog-to-digital converter ADC 7507 for analog-to-digital conversion. Then, the CPU 90 may acquire its information through an internal bus 7502 and the signal bus 89, and calculates an LD drive current. The calculated LD drive current is set in the BIAS APC DAC 7516 or the READ APC DAC 7518, and transmitted to the current source 7544 or a current source 7541 without the comparison amplifier in between.

The waveform generating unit comprises a PLL circuit 7508, a modulation circuit 7509 and a high-frequency wave superposition circuit 7548. The PLL circuit 7508 receives a recording clock to generate a timing signal necessary for the modulation circuit 7509. The modulation circuit 7509 interprets the recording data to generate a recording waveform in accordance with a control signal set by the internal bus 7502, and decomposes the recording waveform into current source control signals indicating the on/off of the respective current sources.

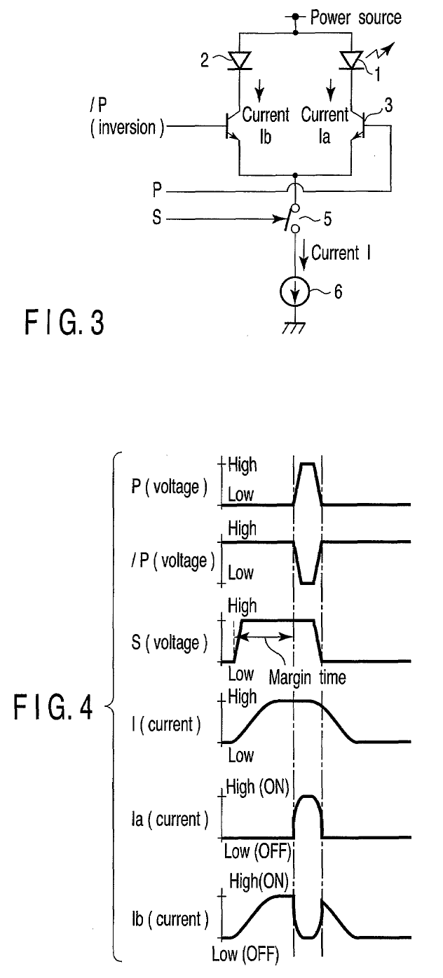

The current source control signals are connected to a PEAK switch 7543 and a BIAS switch 7544, respectively. Consequently, the respective current sources are turned on/off, such that the strength of the LD drive current increases or decreases, and the strength of the irradiation power during recording is modulated. The PEAK switch 7543 serves as a switching circuit described below with FIG. 3, and the waveform generating unit provides this switching circuit with a PEAK switch drive signal which is a differential on/off signal for switching the drive current, and with a PEAK current source switching signal for switching the current sources. The BIAS switch 7544 can have the same structure as the PEAK switch 7543, but is typically not required to be as high in velocity and therefore have a normal structure of a switching element. That is, the output of the waveform generating unit is regulated by any one of the on/off output of a current source switch and a differential switch.

A READ switch 7545 is a switch of the current source which is only turned on mainly during reproduction, and is turned on/off by a control circuit 7510 in accordance with a recording/reproduction switching signal contained in the control signal from the signal bus 89. The high-frequency wave superposition circuit 7548 outputs a sinusoidal wave with amplitude and a frequency that are determined by the control signal set by the internal bus 7502 in the range of about 100 MHz to 1 GHz. Moreover, the output current of the high-frequency wave superposition circuit 7548 is controlled by an HMF switch 7547 whose on/off is controlled by the CPU 90 through the internal bus 7502, and a high-frequency current is superposed mainly during reproduction.

That is, in the laser modulation control circuit 75 shown in FIG. 3, a switch 5 is provided for a current source 6 connected to first and second transistors 3 and 4 for performing differential switching in the PEAK switch circuit 7543. Thus, the switch which is the current source is driven before the differential switching, such that it is possible to reduce the time of the passage of the current to the dummy load (dummy load diode) 2 and reduce unnecessary power consumption without sacrificing the rise time/fall time of the drive current.

In addition, it goes without saying that the laser modulation control circuit described above with FIG. 2 serves for a test write in the recording layer of the optical disc and for the reproduction of the recording mark in the optical disc drive (information recording/reproducing apparatus) shown in FIG. 1, thereby doubling as a waveform generating circuit for a write strategy (optimization of a recording waveform (laser)).

FIG. 3 is a schematic diagram explaining a PEAK switch circuit (light emitting element drive circuit) incorporated in the laser modulation control circuit shown in FIG. 2.

The light emitting element drive circuit comprises a laser diode (light emitting element) 1, a dummy load diode 2, first and second transistors 3 and 4 which are differentially switched, a switch 5, and a current source 6. In addition, the switch 5 and the current source 6 are generally composed of semiconductor elements, but are schematically shown here for simplification. Moreover, the current/voltage characteristics of the dummy load diode 2 are desirably close to the characteristics of the laser diode 1.

An input P (a PEAK switch signal in FIG. 2) is connected to the first transistor 3, and an input /P (an inversion PEAK switch signal in FIG. 2) is connected to the second transistor 4. In addition, inputs P, /P are binary voltage inputs, and are in a complementary relation.

An input S is connected to the switch 5. Input S is also a binary voltage input. As shown in FIG. 4, a current is passed to the switch 5 when the voltage is at a high level, and the switch 5 is open and no current is passed thereto when the voltage is at a low level.

However, it is known that turning on/off the current by the switch 5 is nothing but the generation of pulsations of a current in the power source of the drive circuit, and the effects of unshown parasitic inductance present in the power source and along wiring paths become obvious such that it is not possible to turn on/off a high-velocity current having a rise time/fall time of about 1 ns.

Thus, as shown in FIG. 4, a current I (current source) and currents Ia (a drive current of the laser diode), Ib (a current to the dummy load) are obtained by input /P, input /P and input S (an input is provided in the following order when a current pulse is generated in the laser diode 1).

That is,

1) before input P is changed from low level to high and input /P is changed from high level to low, input S is brought to a high level (by turning on the switch 5), and the passage of the current I is started.

Then,

2) the time when the current I is stabilized is awaited, and input P is changed from low level to high and input /P is changed from high level to low, and then a current Ia is passed to the laser diode 1.

Subsequently,

3) at the point where a time for a necessary pulse width has passed, input P is changed from high level to low and input /P is changed from low level to high, and the current Ia to the laser diode 1 is stopped (a current Ib is passed to the dummy load diode 2). At the same time or after waiting for the passage of time before the current Ia is stopped, input S is brought from high level to low, and the current I is stopped.

Thus, the passage of the current I is first started using the switch 5 with a slow rise time, and then the current is switched by the early changing the first transistors 3 (driven for the laser diode 1) and the second transistors 4 (dummy load diode 2), such that it is possible to reduce the time of the passage of the current to the dummy load diode 2 without sacrificing the rise time/fall time of the drive current to the laser diode 1.

For example, in the case where a pulse width of 500 ps is generated in a period of 4 ns, a current is passed to the dummy load diode D2 for 3.5 ns when the switch 5 is not used. In contrast, according to the method shown in FIG. 4, it is possible to hold down the time of the passage of the current to the dummy load diode 2 to about 1 ns and reduce the power consumption by about 70%, which however depends on how early the switch 5 is activated (margin time).

Furthermore, such a nature is suitable for the “sub-nanosecond pulse recording” in which the duty ratio (the ratio of on-time) is smaller than 1:1 (50:50), for example, about 10% (1:9) and in which light emission with an early rise time is required in a period of several ns.

In addition, in the example in FIG. 3, NPN transistors are used for the first and second transistors 3 and 4, and the laser diode 1 and the dummy load diode 2 are connected to a common anode. However, it is also possible to construct a circuit by using PNP transistors and connecting the diodes to a common cathode.

Moreover, it goes without saying that a field effect transistor can be used to achieve similar driving.

Furthermore, the laser diode 1 and the dummy load diode 2 do not have to be diodes, and resistors or other elements can be used as loads.

According to this invention, in obtaining sub-nanosecond class pulse laser light with a low duty ratio, the power consumption can be drastically reduced as compared with existing driving schemes.

This significantly reduces heat generation in and around the light emitting element.

In addition, in the “sub-nanosecond pulse recording” described with FIG. 1 to FIG. 4, pulsed emissions of laser are performed in which the emission time of the laser is less than 10% (1% to 10%) of a mark length which is one of the recording mark array to be recorded on the optical disc (information recording medium), so that the average value of the power of the laser light during recording may be less than that of the power for reproduction.

On the other hand, the difference of reflectance between a mark portion and a space portion may be small depending on the material of the optical disc as a recording medium. Therefore, there has been developed a recording medium in which the reflectance of the mark portion or the space portion is decreased to about 2% when information is recorded in order to improve apparent contrast.

When the recording method based on the sub-nanosecond pulse is applied to the recording of information on such a recording medium, an average amount of light returning to the photodetector in the optical head during recording is significantly small. Thus, the quality level of a detected signal is significantly degraded, and it may be impossible to perform the operation (focusing/tracking servo) of obtaining an error signal from the detected signal to fix the objective lens to a predetermined position in the recording layer.

Thus, the inventor has proposed the optical disc drive shown in FIG. 1 as an information recording/reproducing apparatus which increases the average amount of light by the superposition of a high-frequency signal between recording pulses to perform recording based on the sub-nanosecond pulse and which can also normally perform the focusing/tracking servo.

However, in order to perform the recording based on the sub-nanosecond pulse, attention has been focused on the presence of further problems. That is, when the high-frequency signal is superposed between the recording pulses, unnecessary relaxation oscillation is generated in a semiconductor laser if there is a great difference between the potential (or current) level of the edge of the recording pulse and the potential (or current) level of the continuous high-frequency signal. When there is unnecessary relaxation oscillation, the laser light becomes uneven, leading to a disturbed recording mark and a disturbed reproduction signal.

Thus, the high-frequency signal is superposed between the recording pulses to prevent the generation of the unnecessary relaxation oscillation.

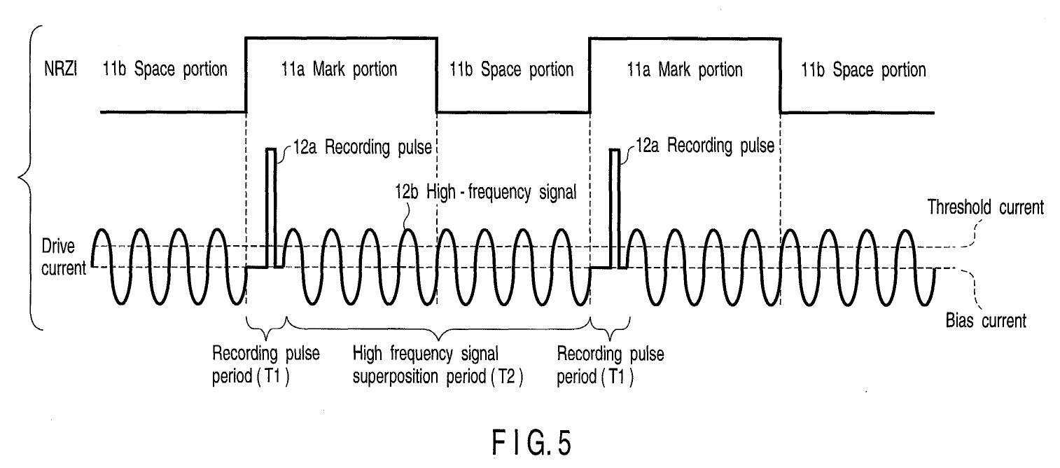

In one example of this shown in FIG. 5, when data (NRZI) to be recorded and a drive current waveform of the corresponding laser diode (LD) contain a recording pulse period (T1) and a high-frequency signal superposition period (T2), a recording pulse 12a is output one or a plurality of times in a mark portion 11a. Further, other than the recording pulse period (T1), a high-frequency signal 12b is output independently of the mark portion 11a and a space portion 11b. Thus, the average strength of the laser diode is maintained.

Owing to the drive current in the recording pulse period (T1), the laser diode emits stronger light in the recording pulse period (T1) than in the high-frequency signal superposition period (T2). Due to this strong light emission, the recording layer of the optical disc thermally changes, and a recording mark is formed. The drive current in the high-frequency signal superposition period (T2) has such a value that the average light strength of the laser diode does not thermally or optically change the recording layer of the optical disc.

This light strength is often the strength at which information is read from the recording layer of the optical disc. The level of a threshold current shown is a level which serves as a boundary between the start and stopping of the light emission of the laser diode. In order to obtain the relaxation oscillation, the laser diode requires a recording pulse which rapidly changes from a level equal to or less than this threshold current level. Therefore, for recording, it is necessary to once decrease the current to a current equal to or less than the threshold current from a current value for obtaining light strength to read information from the recording layer of the optical disc, and then obtain the rapidly changing recording pulse 12a. In a recording mode, the light strength for reading information from the optical disc is necessary when, for example, an address is read.

A period may be provided between the recording pulse 12a and the high-frequency signal 12b so that the drive current is fixed as a bias current.

As described above, in the recording using the sub-nanosecond pulse, a state called the relaxation oscillation is created in the laser diode to obtain light with high emission strength. Therefore, light emission sustains with attenuating emission strength even after the drive current has been stopped from the recording pulse 12a. Stable recording is enabled by providing a bias period with a constant drive current after the recording pulse 12a until the relaxation oscillation settles down. In addition, as has already been described, the recording pulse 12a is generated from an LD drive signal output from the waveform generating circuit of the laser modulation control circuit shown in FIG. 2.

That is, the timing signal generated in the PLL circuit 7508 of the waveform generating circuit is decomposed into the current source control signals indicating the on/off of the respective current sources, which are supplied to the switches 7543 and 7544, respectively.

Accordingly, the outputs of the respective current sources are turned on/off, such that the strength of the LD drive current increases or decreases, and the strength of the irradiation power during recording is modulated. The switch 7545 is a switch of the current source which is only turned on mainly during reproduction, and is turned on/off by the control circuit 7510 in accordance with a recording/reproduction switching signal contained in the control signal from the signal bus 89.

The high-frequency wave superposition circuit 7548 outputs a sinusoidal wave with amplitude and a frequency that are determined by the control signal set by the internal bus 7502 in the range of about 100 MHz to 1 GHz. The output current of the high-frequency wave superposition circuit 7548 is controlled by the switch 7547 controlled by the modulation circuit 7509, and the intermittent superposition of the high-frequency current shown in FIG. 1 is carried out.

In the above description, one kind of relation between the drive current of the laser diode and the NRZI waveform has been shown as in FIG. 5 for clarity of explanation. However, various waveforms are used as the NRZI waveform in accordance with channel data. Moreover, in accordance with this NRZI waveform, a recording pulse for effectively forming the mark portion and the space portion in the recording medium is generated.

According to this invention, in obtaining the sub-nanosecond class pulse laser light with a low duty ratio, the power consumption can be drastically reduced as compared with existing driving schemes. This significantly reduces heat generation in and around light emitting element.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A light emitting element driving circuit comprising:
a light source;
a first switching element configured to switch the light source;
a dummy load element connected in parallel to the light source;
a second switching element configured to switch the dummy load element; and
a switching circuit configured to control a connection between the first and second switching elements, and a constant current source.

2. The light emitting element driving circuit of claim 1, wherein the first switching element and the second switching element are differentially operated.

3. The light emitting element driving circuit if claim 2, wherein the switching circuit is turned on a predetermined time before the first or second switching element is turned on.

4. An information recording/reproducing apparatus comprising:
a laser element configured to record information in a recording layer of a recording medium or to output light at a predetermined wavelength to reproduce information from the recording layer;
a first switching element configured to switch the laser element;
a dummy load element connected in parallel to the laser element;
a second switching element configured to switch the dummy load element;
a switch configured to control a connection between the first and second switching elements and a constant current source;
a light guiding system configured to guide the light at the predetermined wavelength from the laser element to the recording layer of the recording medium;
a light receiving system configured to pick up reflection light produced by the reflection of the light at the predetermined wavelength on the recording layer of the recording medium and to output a reproduction signal corresponding to the intensity of the reflection light; and
a control circuit configured to control the intensity of the light at the predetermined wavelength output from the laser element based on the reproduction signal obtained by the light receiving system.

5. The information recording/reproducing apparatus of claim 4, wherein the first switching element and the second switching element are differentially operated.

6. The information recording/reproducing apparatus of claim 4, wherein the switch is turned on a predetermined time before the first or second switching element is turned on.

7. An information recording/reproducing apparatus comprising:
an optical head device, the optical head device including:
a laser element configured to record information in a recording layer of a recording medium or to output light at a predetermined wavelength to reproduce information from the recording layer;
a first switching element configured to switch the laser element;
a load element connected in parallel to the laser element;
a second switching element configured to switch the load element; and
a switch configured to control a connection between the first and second switching elements, and a constant current source;
a light guiding system configured to guide the light at the predetermined wavelength from the laser element to the recording layer of the recording medium;
a light receiving system configured to pick up reflection light produced by the reflection of the light at the predetermined wavelength on the recording layer of the recording medium and to output a reproduction signal corresponding to the intensity of the reflection light;
a control circuit configured to control the intensity of the light at the predetermined wavelength output from the laser element based on the reproduction signal obtained by the light receiving system;
an information reproducing circuit configured to reproduce the information recorded in the recording layer of the recording medium from the reproduction signal; and
a laser modulation control circuit configured to supply the control circuit with a recording signal whose intensity is changed in accordance with information to be recorded.

8. The information recording/reproducing apparatus of claim 7, wherein the first switching element and the second switching element are differentially operated.

9. The information recording/reproducing apparatus of claim 7, wherein the switch is turned on a predetermined time before the first or second switching element is turned on.

10. A method of driving a light emitting element, the light emitting element comprising a first switching element configured to switch a light source, a second switching element configured to switch a load element connected in parallel to the light source, and a switch configured to control the connection between the first and second switching elements and a constant current source, the method comprising:
differentially operating the first switching element and the second switching element; and
turning on the switch a predetermined time before turning on the first or second switching element.
